(19) United States
(12) Patent Application Publication
(10) Pub. No.: US 2018/0121985 A1
(43) Pub. Date: May 3, 2018

(54) ORIGIN-CONNECTED SATELLITE INFORMATION SYSTEM FOR PROTECTION FROM CLIMATE CHANGE

(71) Applicant: Jeom-Doo Kim, Seoul (KR)

(72) Inventor: Jeom-Doo Kim, Seoul (KR)

(21) Appl. No.: 15/435,004

(22) Filed: Feb. 16, 2017

(30) Foreign Application Priority Data
Nov. 1, 2016 (KR) 10-2016-0144306

(51) Int. Cl. G06Q 30/06; G06K 19/06; G06F 17/30

(52) U.S. Cl. CPC G06Q 30/0625; G06F 17/30241; G06K 19/06028

(57) ABSTRACT

The present invention relates to a satellite information system for protection from climate change, comprising a combined structure of a Green Climate Platform provided with databases for inputting and storing satellite-transmitted macro-information incorporating various analytical data, such as the quality of soil, water and atmosphere of the origin state and the provenance where the goods are produced, as well as the micro-information on the environmental management of the goods, the result of such management put into practice, the producer's personal history, etc.; the Green Climate Code for attachment to the goods that enables one to search and identify the information on the goods inputted and stored in the databases; and the NS Code that enables one to search and identify the information on the genetic safety of the goods.

According to the present information, the Green Climate Code and the NS Code are allowed to be shown on the goods as long as the environment of the production site and the production method of the goods are not in breach of the value set forth by the international environmental standards, thereby the indication of the Green Climate Code and the NS Code on the goods enables one to recognize the goods as environment-friendly, safe goods. Furthermore, thanks to the Green Climate Code and the NS Code, which enable one to search and identify the information on the goods, the producer and the consumer can share the information on the goods, thereby enhancing the credibility of the goods and promoting the consumers' purchasing power, leading to the producer to produce the goods in such a way as to contribute to the protection from climate change, from an industrial aspect.

This application claims priority to Korean Patent Application No. 10-2016-0144306, which was filed on Nov. 1, 2016, wherein the entirety of said patent application is incorporated herein by reference.

### TECHNICAL FIELD

The present invention relates to a satellite-transmitted information system for protection from climate change connected with the provenance of goods, i.e. the place where the goods are produced. More specifically, the present invention comprises a Green Climate Platform provided with a database inputted and stored with satellite-collected macro-information incorporating various analytic data such as the quality of soil, water, atmosphere, etc. of the place where the goods are produced, as well as micro-information containing various analytical data concerning the environmental management of the goods produced, the actual result of such management performed, the personal history of the producer; the Green Climate Code to be put on the goods by which one can search and identify the information contained in the database; and the NS Code provided with a search-identify function to ascertain the genetic safety of the relevant goods.

According to the present invention, the Green Climate Code and the NS Code are allowed to be attached only on the goods at which production site the environmental and production method comply with the value designated by the international environmental standards, thereby by the simple fact of the Green Climate Code and the NS Code attached on the goods can assure the consumer of the environment-friendly safety of the goods. As well, thanks to the Green Climate Code and the NS Code which enable one to search and identify the information on the goods, the producers and the consumers can share the information on the goods on hand, leading to the enhancement of the credibility, as well as to the promotion of the consumers' purchasing power of the goods, whereby the producers can produce the goods in such a way as to contribute to the protection from climate change from the industrial aspect.

### BACKGROUND

The climate change that occurs on the earth are caused partly by the natural phenomena in the universe and the earth, such as earthquake, volcano explosion, and the appearance of a meteor, but the major contributing factor is the reckless destruction of the natural environment perpetrated by humanity.

The enormous household waste material pouring out in the populous cities, sewage, various kinds of fertilizing and disinfection chemicals abusively used over a long period of time, large quantities of polluted smoke containing harmful chemical substances, and industrial waste material and waste water pouring out from various industrial sectors, have seriously contaminated the soil, underground water, the sea and the atmosphere.

In particular, the contaminated atmosphere and ocean is not limited to a regional problem; it is a threat to all humanity living on the earth.

Even more serious is the fact that the volume of the carbon dioxide (CO2) in the atmosphere is increasing day by day. The carbon dioxide in the earth's atmosphere in 2015 was approx. 2000 ppm, whereas the CO2 volume in 2016 exceeded 4000 ppm. The temperature on the earth is said to increase by 1 degree Centigrade per each 1000 ppm.

The continuous global warming led to the shrinkage of the glaciers in the Arctic region, the disappearance of the regional four-season distinction, the derangement in the distribution of ecosystem, the repetition of drought and floods irrespective of season and region, resulting in serious loss and damage to the farming population, as well as to the public property and private sectors. Moreover, the adverse effects caused by global warming brought about famine and disease, making it increasingly difficult for humanity to lead a normal, happy life.

With awareness of the serious problem caused by climate change and in an endeavor to overcome this problem, a new international organization to tackle the climate change problem, i.e. the United Nations Climate Change Conference (UNCCC), was established under the supervision of the United Nations aimed at reducing carbon dioxide (CO2). The UNCCC is exploring various measures to reduce the earth's average temperature by 1.5 degrees Centigrade (SC). However, only limited success has been attained so far.

The limited success is attributable to the lukewarm attitude of the advanced industrial nations whose emission of carbon dioxide is greater than that in less-developed nations, for fear of their industries being affected.

In an attempt to further their cause, the UNCCC member states issued the Kyoto Protocol and thereafter the Paris Agreement in order to arrive at a decision to hold the general convention of the UNCCC, the Conference of Parties (COP20), in 2020 for a new UN Framework Convention on Climate Change to discuss ways to cope with the climate change even more vigorously in order to broadly deal with measures to strengthen the financial and technological capacity and to enhance the practical transparency, as well as the reduction of greenhouse gas. The Kyoto Protocol had concentrated solely on the issue of reducing greenhouse gasses.

Undoubtedly, various systems have been put in place in order to prevent environmental contamination, issuing certification for environment-friendly excellent goods. However, the contribution to the protection from climate change by the goods producers—who are providers of adverse effects of climate change—remains limited.

Meanwhile, the technology and equipment for freeing or alleviating various types of environmental contamination are proposed in various forms as a new industrial sector.

Listed in the following paragraphs is the patent literature concerning the prior arts related to environmental decontamination:

### PRIOR ART PATENT LITERATURE

[Cited Reference 1] Published Registered Korean Patent No. 10-1421252 (published dated 18 Jul. 2014)

[Cited Reference 2] Published Registered Korean Patent No. 10-1096055 (published dated 26 Aug. 2010)

[Cited Reference 3] Published Registered Korean Patent No. 10-1202677 (published dated 23 Sep. 2013)

### DETAILED DESCRIPTION OF THE INVENTION

### Problems to be Resolved

Various types of devices and methods aimed at decontaminating the contaminated soil, water and air are known. No doubt, it is important to decontaminate the contaminated environment. However, it is more important to remove or alleviate the cause of environmental contamination.

Generally, attached on the certified goods or their packages is a certification or a mark thereof showing that the goods are excellent. However, the consumer cannot have easy access to the information on the reason why the goods are excellent. As to the origin of the goods, only the name of the origin state is shown on the origin tab or certificate of origin issued upon exports/imports. As a result, the consumer is at a loss to know the detailed information on the place where the goods are produced, i.e., the provenance where the goods are produced, and what is the environmental surroundings of the production site like.

The producers are inclined to promote only the excellence of their goods, with reluctance to disclose the detailed environmental production method at the actual place of origin. As yet, no workable device or legal system has been introduced to sanction such behavior.

### Means to Resolve the Problem

In order to help the producers to produce goods in such a way as to prevent environmental contamination as best as possible before decontaminating the already-contaminated environment, the present invention developed “a satellite information system for protection from climate change” aimed at providing satellite-transmitted information system showing the historical background of the place of production of the origin state designed for protection from climate change, comprising a Green Climate Platform (GCP) provided with a database inputted and stored with satellite-collected macro-information incorporating various analytic data on the production site, such as the quality of soil, water, atmosphere, etc. of the goods, as well as micro-information comprising various analytical data concerning the environmental management of the goods produced, the actual outcome of such management performed, the personal history of the producing people; the Green Climate Code (GCC) that is to be put on the goods by which one can search and identify the information contained in the database; and the NS Code (New Environmental Protection and Safety Code) provided with a search-identify function to ascertain the genetic safety of the relevant goods. Through the GCC and the NS Code the producers and the consumers can share the information on the goods/products, thereby enhancing the credibility of the goods, promoting the consumers' purchasing power, leading the producers to produce their products in such a way as to contribute to the protection from climate change.

The object of the present invention is to provide macro-information obtained from a satellite, comprising the analytical data concerning the quality of soil, water and atmosphere of the place of origin, i.e. the provenance of the goods and the micro-information with analytical data on the environmental management and its actual outcome, as well as the producer's personal history stored in the Green Climate Platform database, enabling the producer and the consumer to share the transparent information on the goods

Another object of the present invention is to provide a satellite-transmitted information system for protection from climate change, wherein the consumers can identify with their own eyes the safety of the goods that has much to do with their own life via the NS Code, thereby facilitating their decision to purchase goods.

Still another object of the present invention is to provide a satellite-provided information system for protection from climate change, wherein the consumers can identify the information on the quality of the goods by the Green Climate Code and the NS Code, thereby urging the producers to engage in environment-friendly production, thus contributing to the protection from climate change, by such means as reducing the generation of carbon dioxide.

### DETAILED EXPLANATION ON THE INVENTION

Following is a detailed explanation of the invention.

The present invention, i.e. the Satellite information System on the Place of Origin comprises a Green Climate Platform provided with a database stored with macro-information incorporating various analytical data on various items, such as the quality of soil, water, and atmosphere, and the micro-information provided with analytical data on the environmental surroundings of the place of origin, i.e. the provenance, such as the quality of soil, water, and atmosphere, as well as the environment of the production site, production method, and producer's personal history; the Green Climate Code by which one can get access to certain item of one's choosing in the database so that one can identify it with his or her own eyes or one can search it through the Internet mobile; and the NS Code designed for five major indices, focusing on the genetic safety analysis of the goods for the consumers' safety of life and the danger factor of the earth's ecosystem.

The Green Climate Platform comprises a data input port, a data input control server that controls data input, and a Database Multiple Unit Control Port. The database comprises a number of databases, such as one that stores the address of the origin state and the production site, as well as the data on the coordinates of the satellite, one that stores quality of soil, water and atmosphere of the origin state and of the production site, one that stores the analytical data on the soil of the production site, one that stores the analytical data on the water quality of the production site, one that stores the analytical data of the atmosphere of the production site, one that stores the goods classification data based on the international standards of HS code, one that stores the genetic analysis data, one that stores the safety analysis data on the goods and food, one that stores the outcome of the actually performed environmental production management, and one that stores the producer's personal history data.

The satellite information also comprises the satellite-transmitted color photograph of the production site of the origin state visible both in a plane map and in a three-dimensional map, as well as the analytical data on the quality of soil, water, and atmosphere of the place of origin, i.e. the production site of the origin state.

The micro-information comprises the precision analytical data covering various data of the quality of soil, water, and atmosphere actually collected and detected from the production site, as well as the outcome of the environmental management that has been put into practice, the personal history of the producer of the goods, etc.

Continuously inputted into the database of the Green Climate Platform connected with the climate-observation satellite are the analytical data on the quality of soil, water, and atmosphere of the production site, such information being updated continually; the information on the analytical data of the place of origin, i.e. on the quality of soil, water, and atmosphere of the production site, as well as the information on the goods, is continually inputted and stored into the database at a regular time interval.

Therefore, as the information in the database is continuously updated and renewed, the information on the place of origin, which the consumer searches and obtains on the production site, is the up-to-date latest information rather than the information as at the time of shipment of goods. Therefore, the information thus obtained is highly accurate and credible.

As the database contains the quality of soil, water, and atmosphere set forth by the international environmental standards value and the genetic analysis data, one can, where necessary, compare the information on the site of the place of origin stored in the database with the value and the data set forth by the international environmental standards.

The Green Climate Code, by which one can get access to the database to search information, consists, for convenience's sake, of 6 items and 24-digit Arabic numerals.

The first item of the Green Climate Code is the five-digit numbered producer's Identification Code; the second item is the one-digit numbered System Check Code; and the third item is three-digit numbered Origin State Code; the fourth item is the three-digit numbered Provenance (or Place of Origin) Code; the fifth item is the six-digit numbered Goods Classification Code based on the International Goods Classification Code (HS); and the sixth item is the six-digit numbered Goods Shipment Serial Number Code.

In particular, the origin state in the third item of the Green Climate Code consists of the state code number for international telephone; the provenance code in the fourth item consists of the regional telephone code number, from which numbers one can easily identify the production site and the origin state.

The Green Climate Code is shown in an ordinary one-dimensional code or two-dimensional code recognizable via the mobile communication device or composite communication means or Internet of Things (IoT). In order to cope with the situation where the Internet or the mobile phone is unusable or where such communication system is paralyzed, the information is shown in Arabic numerals side by side in such a way as to be visible with one's own eyes.

Therefore, it is possible to use the Green Climate Code without the help of information-communication equipment in any country in the world.

The NS Code is designed for a consumer to identify the safety of the goods with his or her own eyes, and consists of five major indices, for example, comprising the information on genetic modification, safety of goods, prevention of environmental contamination, production method, and production requisites, each index setting nine grades of achievement from one to nine, thus each index marking the degree of the safety of goods and of the earth's ecosystem danger factor with numerals. The grade set by each index is evaluated based on the goods-safety data stored in the database of the Green Climate Platform at the time when the NS Code was generated.

The lower the index numeral is, the lower is the danger factor of the goods from the perspective of sanitary safety and of the earth's ecosystem.

The operational effects of the present invention as constructed above are explained by means of their sequential order as follows.

(1) The Generation of the Green Climate Code and the NS Code:
In the first place, the producer of goods applies for the generation of the Green Climate Code and the NS Code.
The applicant connects himself or herself to the Green Climate Platform via the Internet and inputs the information such as the address of the origin state and the production site, the satellite coordinate of said address, the goods classification code unique to the goods (numeral), etc. If the inputted address of the producing state and the production site do not match the value of the satellite coordinate, the code generation operation does not proceed to the next step. If the address and the satellite coordinate match, the generation operation moves to the next step.
   If the quality of the soil, water, and atmosphere of the origin state and the production site and other data relevant to the goods are not in breach of the value set forth in the international environmental standards, the software exclusive for the code generation comes in operation, giving birth to the one and two dimensional (QR) code of the Green Climate Code. The Green Climate Code thus generated is printed on the label paper or on the packaging paper by the exclusive Green Climate Code printer, thereby concluding the code generating operation. Now the producer can put the Green Climate Code label on the relevant goods.
   In the meantime, if the producer accesses the Green Climate Platform and applies for the NS Code, and if the information on the goods stored in the Green Climate Platform database concerning the five major indices, i.e. the genetic modification, safety, prevention of environmental contamination, production method, and production requisites, is not in breach of the value set forth in the international environmental standards, the NS Code software comes into operation, leading to the generation of the NS Code with an indication of the grades for five major indices. The NS Code thus generated is printed on the label or on the packaging paper by the printer exclusive for the NS Code, thereby completing the operation. Now the producer may put the NS Code label on the relevant goods.
   In other words, as long as the various data on the place of origin of the goods meet the value of the international environmental standards set forth in any one of the international environmental organizations, i.e. the World Health Organization (WHO), Food and Agriculture Organization (FAO), the United Nations Environment Program (UNEP), the European Union Standards and the United States Environmental Standards, the Green Climate Code and the NS Code are generated and made available for attachment to the relevant goods.

(2) The Use of the Green Climate Code and the NS Code
The fact that the Green Climate Code and the NS Code are attached to the goods provides the certification that the goods are produced in such a way as to contribute to the protection from climate change and that the goods provides safety assurances for human life with less danger factor for the earth's ecosystem.

Meanwhile, if the consumer wishes to know the information on the quality and the place of origin of the goods, he or she can search and identify such information using the Green Climate Code.

In other words, in the case of search work on the personal computer (PC) via the Green Climate Code, the consumer logs in the Green Climate homepage; inputs the name of the goods, then he or she accesses the Green Climate Platform website. Then various kinds of information on the goods, such as the origin state and production site, which are stored in the Green Climate Platform database, are displayed on the window of the PC, thereby the consumer comes to know both the macro-information and the micro-information on the place of origin of the goods, whereby the consumer make a decision on the purchase of the goods based on the information thus obtained.

Meanwhile, for instance, if the producer wishes to make repayment in some form for the consumer who decided to purchase his or her goods after the consumer's search work for the information on the place of origin, the producer can do so in the wake of the consumer's search work and purchase decision by requesting a voucher, whereupon the Green Climate Code Voucher Management Department issues a voucher online to the consumer. On receipt of the voucher, the consumer can receive the repayment from the producer upon purchase of the goods.

When the consumer wishes to search information via the Internet using a mobile phone, he or she may log in the Green Climate homepage and inputs the name of the goods, as he or she does with the search on the PC, thereby accessing the Green Climate Platform and obtaining the database-stored information on the goods.

If the consumer logs in the Green Climate homepage and scans the one-dimensional code or two-dimensional code with his or her camera, he or she is connected to the Green Climate Platform, thereby obtaining the information on the goods.

The consumer can also obtain the information on the goods by accessing the Green Climate Platform via the Internet, using the short-range wireless communication system, such as NFC, WiFi, Bluetooth, and IoT.

As aforesaid, the information obtained from the Green Climate Platform database by logging in the Green Climate homepage is displayed on the display monitor, showing the macro-information, including the ecosystem of the production site of the origin state, its map, on-spot satellite photographs, as well as the micro-information, such as the analytical data on the quality of soil, water, and atmosphere detected and collected from the production site, environmental management concerned with the goods, the result of such management, and the personal history of the producer.

The search for the information on the goods via the NS Code is little different from that via the Green Climate Code. However, even without a search, the NS Code shows the five major indices for the information on the genetic modification, safety, prevention from environmental contamination, production method, production requisites, with an indication of one to nine achievement grade numerals; the lower the numeral is, the higher is the sanitary safety with the lower earth's ecosystem danger factor. Therefore, based on the information thus obtained, one can decide on the goods and purchase them.

Furthermore, the attachment of the Green Climate Code to the “Origin” column of the goods for exports and imports will facilitate the export and import procedures, as it will enable the customs officials to grasp easily the detailed information on the origin state and the production site.

### Effects of the Invention

According to the present invention, as the satellite-transmitted information on the origin state and the production site of the goods and the micro-information on the production site, i.e. the provenance, and on the goods are incorporated, inputted and stored into the database of the Green Climate Platform website, the producer and the consumer can share the information on the provenance of the goods in a transparent manner.

Furthermore, with the formation of a Green Climate Code by which to access the database of the Green Climate Platform website, only those goods that are not in breach of the value set forth in the international environmental standards are allowed to attach the indication of the Green Climate Code on the goods. Therefore, the simple indication of the Green Climate Code attached on the goods provides high credibility on the goods. At the same time, as the consumer can access the information on the place of origin of the goods through search work via a PC, he or she can feel safe in purchasing the goods. This contributes to promoting the consumers' purchasing power.

Furthermore, the NS Code is designed for the consumer to identify with his or her own eyes the degree of the safety of the consumers' life, by such means as a genetic safety analysis of foods, as well as the degree of the danger factor of the earth's ecosystem. The NS Code is shown only on those goods which are not in breach of the value set forth in the international environmental standards, therefore, the simple indication of the NS Code on the goods leads to the preference for the goods.

An increase in the credibility and preference for the goods contributes to the promotion of the consumers' purchasing power. As the producer and the consumer share the information on the goods, the producer is likely to produce the goods in such a way as to contribute to the protection from climate change, by such means as reducing the generation of the volume of waste water and carbon dioxide in order for the consumers to conceive good reputation of the goods, as well as of the producer.

### BRIEF DESCRIPTION OF THE DRAWINGS

FIG. 1 is an overall view of the present invention.

FIG. 2 is a cluster block view of the databases for the Green Climate Platform in the present invention.

FIG. 3 is a flow chart showing the generation of the Green Climate Code in the present invention.

FIG. 4 is an illustrative view of the Green Climate Code in the present invention.

FIG. 5 is an illustrative view of the NS Code in the present invention.

FIG. 6 is an illustrative view of the label of the one and two dimensional Green Climate Code applied to the package of the goods in the present invention.

FIG. 7 shows flow charts of the search work for the information on the goods via the Green Climate Code in the present invention.

FIG. 8 is an illustrative view of the satellite information on the place of origin searched via the Green Climate Code in the present invention.

FIG. 9 is an illustrative view of the information on the safety of the goods searched via the NS Code in the present invention.

### PREFERRED EMBODIMENT OF THE INVENTION

An embodiment of the present invention is explained in detail by the drawings attached as follows.

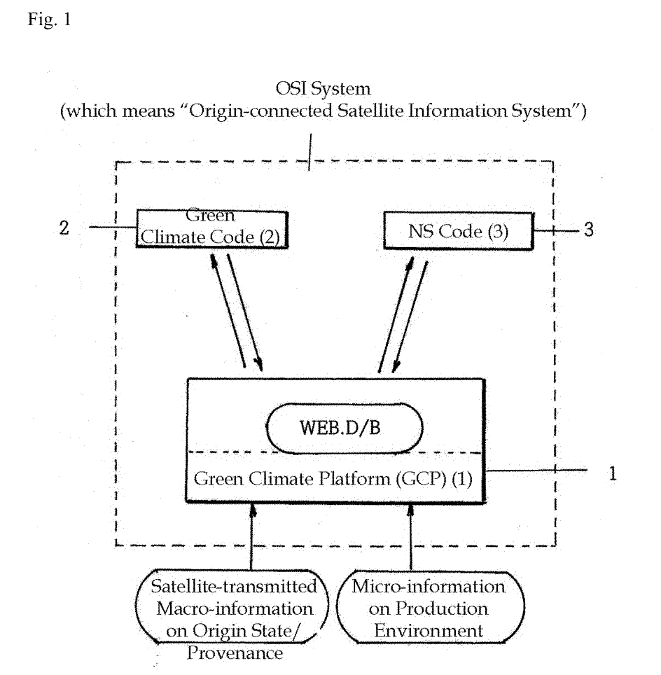

FIG. 1 is an overall view of the construction of the satellite information (OSI) system, which comprises the Green Climate Platform (1) having a database (DB) inputted and stored with the macro-information collected via a satellite, consisting of the analytical data, such as the quality of soil, water, and atmosphere of the origin state/production site, as well as a database inputted and stored with the micro-information containing various items of analytical data, such as the quality of soil, water, and atmosphere of the origin state/production site on the earth; and the Green Climate Code (2) providing a search function for the information on the goods stored in the databases; and the NS Code (3) providing a search function for the safety of the goods.

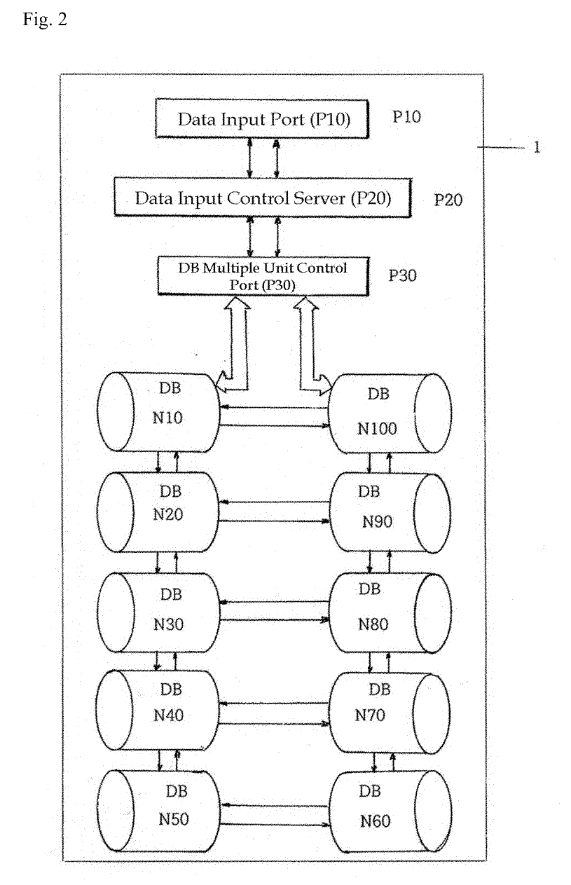

As shown in FIG. 2, the Green Climate Platform (1) is provided with a data-input-control server ((P20) and a Database Multiple Unit Control Port connected with a data-input port (P10). Also connected thereto are a number of databases (D/B's), ranging from N10 to N100) in which data by item are inputted and stored.

Stored in the database (N10), for example, is the address of the origin state/production site, its area, and the value of the satellite coordinate.

Stored in the database (N20) is the macro-information integrally investigated onto the satellite-collected data concerning the origin state/production site, such as the quality of soil, water and atmosphere.

Inputted and stored in the database (N30) is the analytical data on the soil of the origin state/production site, i.e. the physical characteristics of soil for the prevention of soil contamination, such as the topography, the existence of an embankment, the distance from a dam, the distance from a highway, the existence of a well, the properties of soil, the color of soil, the depth of the soil layer, the distance from industrial facilities, the existence of a garbage dump, the gradient of soil, the direction of the gradient, the nature of soil, the size of soil pore, the stickiness of soil, supply of water for soil, the existence of earth and sand coming in, cultivated crop, the soil treatment at the time of crop cultivation, as well as the micro-information containing the measured analytical data on the chemical characteristics of soil, such as the quantity of organic phosphate (ppm), exchangeable kali (me/100 g), the number of atomic group per 100 g), replaceable potassium (me/100 g), exchangeable magnesium (me/100 g), silica (pm), nitric nitrogen (ppm), alkali (%), acidity (degree), and metals, as well as the information on their testing method.

Inputted and stored in the database (N40) are the micro-information, as well as the testing method thereof, on the measured analytic data for the quality of water at the origin state/provenance, such as the general items on the chemical characteristics of the quality of water, i.e. the color of water, the temperature of water, odor, taste, turbidity, the quality and test results of water at the source of water supply, fume of automotive vehicles, amount of rainfall, concentration of hydrogen ion (pH) of water quality, dissolved oxygen (DO), biological oxygen demand (BOD), chemical oxygen demand (COD), ammonia nitrogen, nitrate nitrogen, total phosphorus (T-P), organic phosphorus, fluoride, etc., as well as the measured analytical data on the detected heavy metal and bacterial items.

Inputted and stored in the database (N50) are micro-information, as well as the testing method, on the measured analytic data for the general items on the chemical characteristics of the atmosphere, i.e. the physical characteristics of the atmosphere, such as the annual average wind direction and air velocity, and yellow sand, sulfur dioxide, carbon monoxide, nitrogen dioxide, dust (total dust [TSP]), fine dust ([PM10]), ozone, hydrocarbon, hydrogen chloride, sulfur oxides, nitrogenous compounds, carbon dioxide, methane (CH4), benzopyrene, etc.

Inputted and stored in the database (N60) is the classification of goods based on the NS Code standards.

Inputted and stored in the database (N70) is the information on the data for genetic modification of the farm produce at the origin state/production site.

Inputted and stored in the database (N80) is the information, as well as the testing method, on the analytical data for the safety of the farm produce and food produced at the origin state/production site, including the information on the biological characteristic on the bacteria harmful to the human body, such as salmonella, Staphylococcus aureus, Vibrio parahaemolyticus, Listeria monocytogenes, Escherichia Coli 015, tuberculosis, anthrax bacillus, Cholera vibrio, etc.; information on parasites, such as protozoa, Cestoda, Anguillicola, etc.; information on virus harmful to the human body; micro-information on insecticides, such as r-BHC, DDT, Aldrin, heptachlor, jolen, Carbadox, flubendazole, Methamidophos, etc. These data are connected with the NS Code as well.

Inputted and stored in the database (N90) is the information on the managerial aspect of the production site, i.e. the practice by the managerial personnel of the production site for the reduction of the contamination of soil, water and atmosphere, as well as the objective, practice, and result of the environmental management, including such specific information as the recording of a farming diary, the means to remove environment-contaminating material (device and method), the use of agricultural chemicals, etc.

Inputted and stored in the database (100) is the producer's personal history.

The aforesaid items of information are not restrictive to what is mentioned. They may be increased, reduced, and varied. In other words, the kinds of the data stored in the databases are not restrictive to what is mentioned above; they are shown as an example.

All the information inputted in the databases is inputted via the Data-Input Port (P10) of the Green Climate Platform (GCP). The inputted data are inputted into the by-item databases (N10˜N100) at the Multiple Unit Control Port (P30) through the Data-Input-Control Server (P20).

The macro-information comprising the measured analytical data for the origin state/production site is inputted as occasion calls by the satellite, and the data analyzed on the earth are inputted at certain time intervals. Therefore, the information stored in the databases is continually renewed and updated as the most up-to-date information.

The Green Climate Code, which is accessible for search of information by accessing the databases (D/B) of the Green Climate Platform, making it possible to obtain the certification of the environment-friendliness of the goods, consists of six items and 24-digit numerals, as shown in FIG. 1.

The first item \textcircled{1} of the Green Climate Code is the producer's identification code (ID) number decided on by the producer. The second item \textcircled{2} is the system check code consisting of a one-digit numeral. The third item \textcircled{3} is the origin state code consisting of a three-digit numeral, which is identical with the state code for international phone call. For example, if the origin state is the United States, the origin state code is 001, and if the Republic of Korea is the origin state, the origin state code is 082. Therefore, by looking at the numeral, one can identify the origin state. The fourth item \textcircled{4} is the provenance code consisting of a three-digit numeral, which is identical with the regional code for the local phone call. For example, in the case of the Republic of Korea, if the provenance region is Kyeonggi Provence, the provenance code is 031, if it is 041, the provenance code is for South Chungchong Province. In the case of the United States, for example, the provenance code is 907 for Alaska, 406 for Montana, and 808 for Hawaii.

The fifth item \textcircled{5} is the goods classification code consisting of six-digit numeral according to the International Standard Classification Code (HS). The sixth item \textcircled{6} is the serial number code consisting of a six-digit numeral for shipment of goods.

An example of the construction of the Green Climate Code is shown in the following Table. (The area code for Montana is 406.)

TABLE 1
\textcircled{1} \textcircled{2} \textcircled{3} \textcircled{4} \textcircled{5} \textcircled{6}

| 12345 | 0 | 001 | 406 | 070960 | 123456 |
|---|---|---|---|---|---|
| Pro- | System | Origin State | Provenance | HS Goods | Serial |
| ducer's | Check | (State Code | (Place of | Classi- | Number for |
| ID | | for | Origin) Area | fication | Shipment of |
| | | International | Code | Code | Goods |
| | | Phone Call | | | |

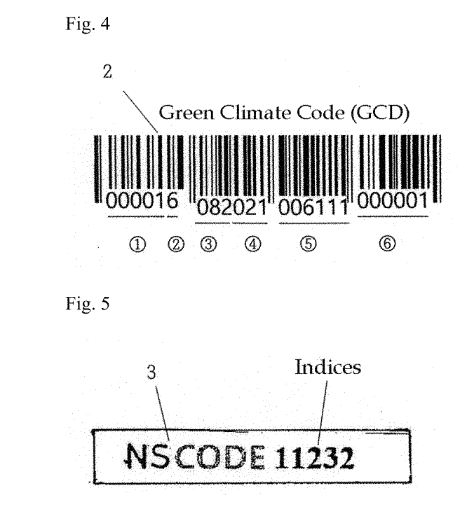

The Green Climate Code is shown in the ordinary one dimensional and two dimensional codes recognizable via a mobile or composite communication means or the Internet of Things. To cope with the situation where the Internet or a mobile communication is unavailable, or where the information system is paralyzed, Arabic numerals are shown in a line as in Table 1 for one to identify the numerals with one's own eyes. Hence, the function of the Green Climate Code is maintained even without the help of the information communication equipment. (Please refer to FIG. 4)

Furthermore, the NS Code comprises five major indices being designed so that one can recognize the safety of the goods with one's own eyes. As shown in Table 2, the first index is for the information on genetic modification and the second index is for the information on safety, the third index is for prevention of environmental contamination, the fourth index is for production method, the fifth index is for production requisites. Each index classifies one to nine (1˜9) achievement grades or levels, thereby marking by each index the safety of the goods and the danger factor of the earth's ecosystem in numerals.

An example of the construction of the NS Code is shown in Table 2 below.

| Index | Item | Grade |
|---|---|---|
| \textcircled{1} | Genetic Modification | 1, 2, 3, 4. 5, 6, 7, 8, 9 |
| \textcircled{2} | Safety Information | 1, 2, 3, 4. 5, 6, 7, 8, 9 |
| \textcircled{3} | Environmental Contamination | 1, 2, 3, 4. 5, 6, 7, 8, 9 |
| \textcircled{4} | Production Method | 1, 2, 3, 4. 5, 6, 7, 8, 9 |
| \textcircled{5} | Production Requisites | 1, 2, 3, 4. 5, 6, 7, 8, 9 |

The items for the NS Code are not restricted to the above-noted ones.

The lower is the grade of the index, the better is the quality of goods with the safety of human life and with the lower danger factor of the earth's ecosystem. (Please refer to FIG. 5)

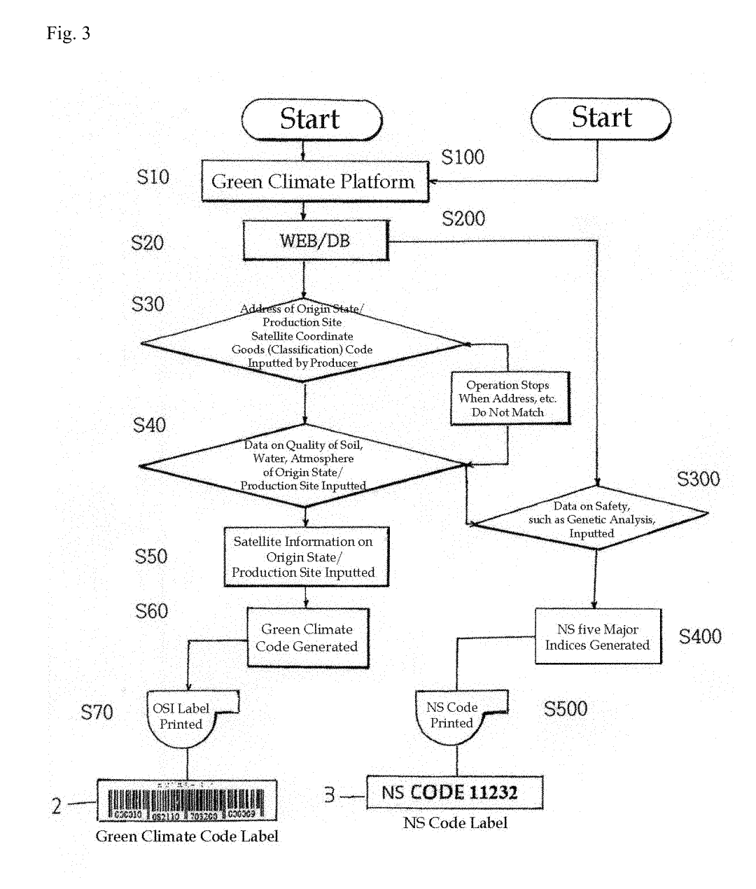

As shown in FIG. 3, the process of the generation of the Green Climate Code is as follows.

The first stage (S10) is for the producer to log in the Green Climate Platform to input the essential data for the generation of the Green Climate Code into the database of the website; the second stage (S20) is to receive the data essential to the Green Climate Code, and to input and store them into the database (DB). The third stage (S30) is to induce the operation of the printer input mode for the Green Climate Code generation, and if the origin state/provenance, and its address, which the producer inputted, match the satellite coordinate, the goods classification code unique to the goods according to the International Standard Classification Code (HS) and the producer's management information are inputted. If the value of the satellite coordinate of the origin state/provenance, its address, etc. do not match, the operation of the generation of the Green Climate Code comes to a stop.

In the fourth stage (S40), the information comprising the analytical data of the goods stored in the database, i.e. the quality of soil, water and atmosphere of the origin state/production site, as well as the environmental management, the practical result thereof and production history, is inputted in the Green Climate Code generating device. In the fifth stage (S50), the satellite on the watch for the earth's ecosystem transmits and inputs into the Green Climate Code generating device the macro-information, such as the quality of soil, water, and atmosphere of the origin state/production site of the goods stored in the database. If these data are not in breach of the standard value of the international environmental standards, the process moves into the sixth stage (S60), wherein the software of the Green Climate Code generating device turns into operation, thereby one-dimensional and two-dimensional Green Climate Code, consisting of the six items, is generated, as shown in Table 1. Then in the seventh stage (S70), according to the one-dimensional and two-dimensional Green Climate Code signal, the Green Climate Code (2) is printed on the label or on the packaging paper, thereby concluding the process of generating the Green Climate Code.

Meanwhile, in line with the generation of the Green Climate Code, the process of generating the NS Code is as noted below, as shown in FIG. 3.

Namely, in the first stage (S100) of the process of generating the NS Code, one logs in the Green Climate Platform and inputs the NS Code essential data. In the second stage (S200), the data transmitted from the first stage (S100) are received, inputted and stored in the database (DB). Then in the third stage (S300), with the NS Code generation information and printer input mode turned into operation, the genetic analysis data, the results of the environmental management/practice of the goods stored in the database, as well as the data value of the third stage (S30) and the fourth stage (S40) of the operational stage of the Green Climate Code are automatically connected and inputted internally into the NS Code generating device. In the fourth stage (S400), unless the analytic data of genetic safety inputted in the third stage (S300) via the NS Code-exclusive software is in breach of the value of the international environmental standards, the NS Code consisting of the five major indices shown in Table 2 is generated. At this time, the grades ranging from one to nine for the five major indices, i.e. the information on the genetic modification, safety, environmental contamination, production method, and production requisites, are determined and the NS Code signal is transmitted to the NS Code-exclusive printer. In the fifth stage (S500), according to the NS Code signal transmitted in the fourth stage (S400), the NS Code (3) is printed on the label paper or on the packaging paper by the NS Code-exclusive printer, thereby completing the process of issuing the NS Code.

The Green Climate Code and the NS Code printed on the label may be attached onto the goods or onto the packaging paper thereof.

FIG. 4 is an illustrative view of the one-dimensional Green Climate Code (2) in the present invention. From the numeral indicated below the barcode, one can identify the origin state, provenance, producer, the kind of the goods, etc. One can also search for the specific information on the goods by scanning the one-dimensional and two dimensional Green Climate Code with a camera.

FIG. 5 is an illustrative view of the NS Code (3) in the present invention. The numeral of NS CODE 11232 means, beginning with the first digit number, that the first index on the genetic modification is grade 1, the second index on the safety information is grade 1, the third index on the prevention of environmental contamination is grade 2, the fourth index on the production method is grade 3, the fifth index on the production requisites is grade 2. The lower the grade numeral is, the better is the goods with less danger factor for the consumers' safety of life and for the earth's ecosystem.

As noted above, from the Arabic numeral of the NS Code, one can identify the safety of the goods with one's own eyes.

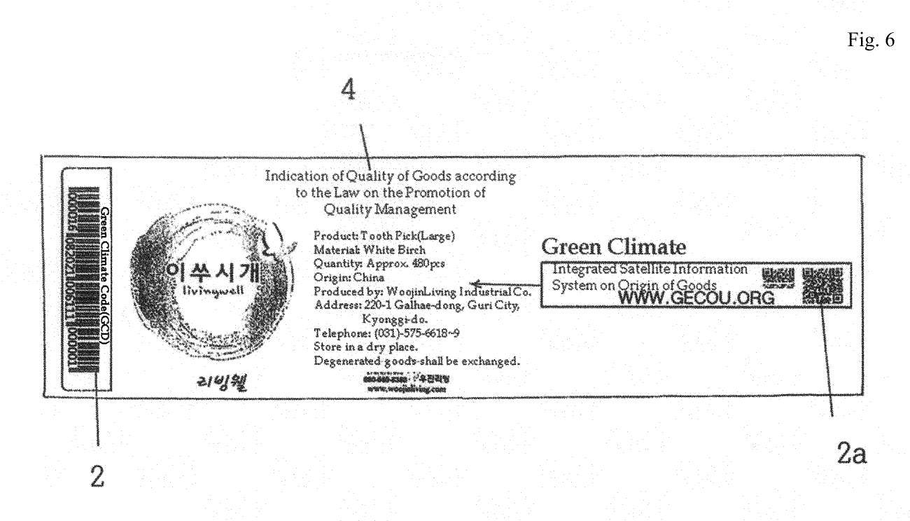

FIG. 6 is an illustrative view of the one-dimensional Green Climate Code (2) and the two-dimensional Green Climate Code (2a) applied onto the packaging paper (4) of the goods in the present invention. In particular, the attachment of the Green Climate Code of the present invention to the origin column of the goods enables one to carry out the speedy information search by scanning with a camera, thereby helping the customs officials carry out their customs clearance work more efficiently.

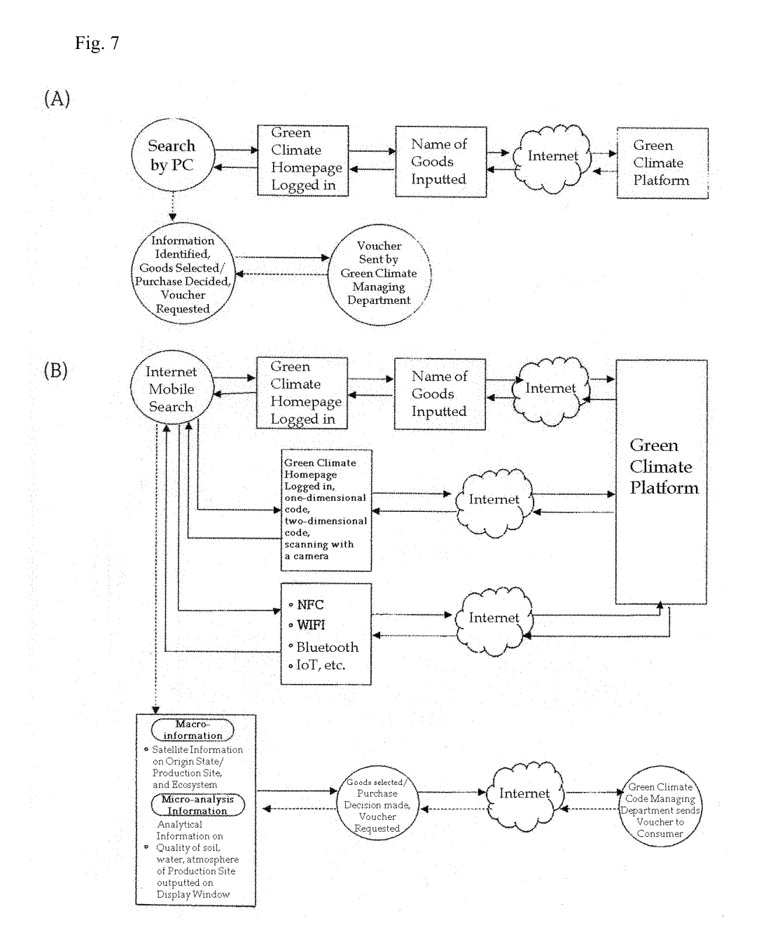

The search process for the information on the goods may be carried out in various ways via the Green Climate Code in the resent invention. As shown in FIG. 7 (A), in the case of a search via a PC, one logs in the Green Climate homepage and inputs the name of the goods, then one accesses the Green Climate Platform via the Internet. Then one identifies the information on the goods stored in the database of the Green Climate Platform website, and makes a decision as to whether he or she would buy the goods or not.

If the producer wishes to offer a voucher to the purchaser of the goods, it is given by the Green Climate Code management department to the purchaser, who requested the voucher, online. Then the purchaser having the voucher receives the repayment on purchasing the goods.

As shown in FIG. 7 (B), in the case of a mobile search via the Internet, one logs in the Green Climate homepage, inputs the name of the goods, accessing the Green Climate Platform via the Internet, as in the case of the search by a PC, thereby one can search for the information on the goods stored in the database.

Also, by logging in the Green Climate homepage, one can scan with a camera the one-dimensional and two-dimensional Green Climate Code. Then one can access the Green Climate Platform via the Internet, thereby one can search for the information on the goods stored in the database.

Also, using the near field communication, such as NFC, WIFI, Bluetooth, and IoT, one can access the Green Climate Platform via the Internet, and search for the information on the goods stored in the database

At this time, the information provided by the Green Climate Platform is macro-information on the origin state/production site, ecotop, etc. Also displayed on the search window is the micro-information on the analytical data, such as the quality of soil, water and atmosphere, the environmental management, the result of such management practiced, the producer's personal history, etc.

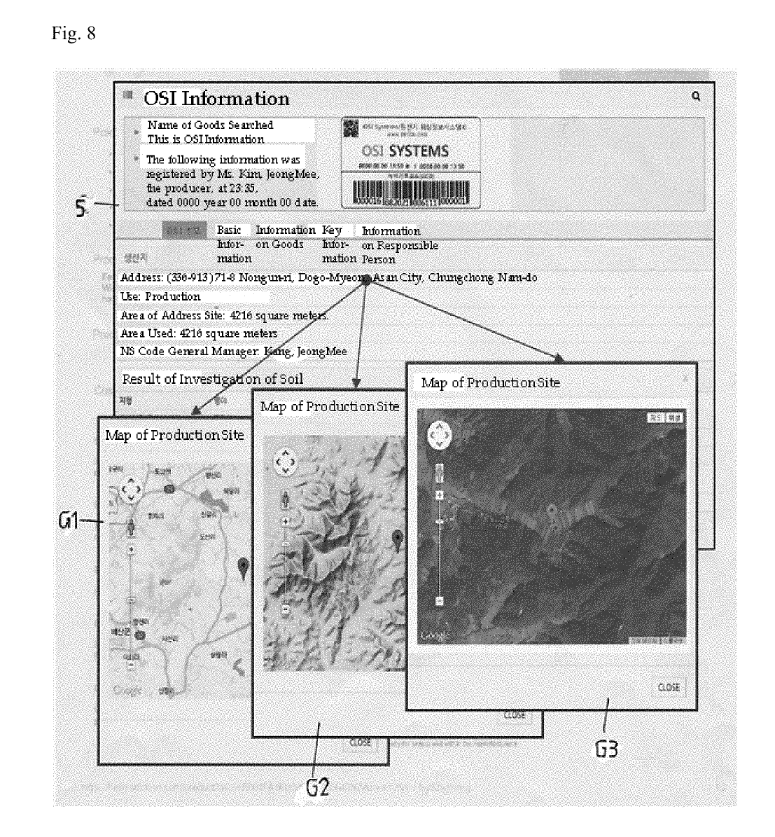

FIG. 8 is an illustrative view of the satellite-transmitted information searched for via the Green Climate Code in the present invention. Shown on the information paper (5) is the map (G1) of the production site of the goods and the satellite-transmitted photographs (G2) (G3). The consumer can grasp the environment of the production site of the goods he or she wishes to buy more accurately from the satellite-provided information,

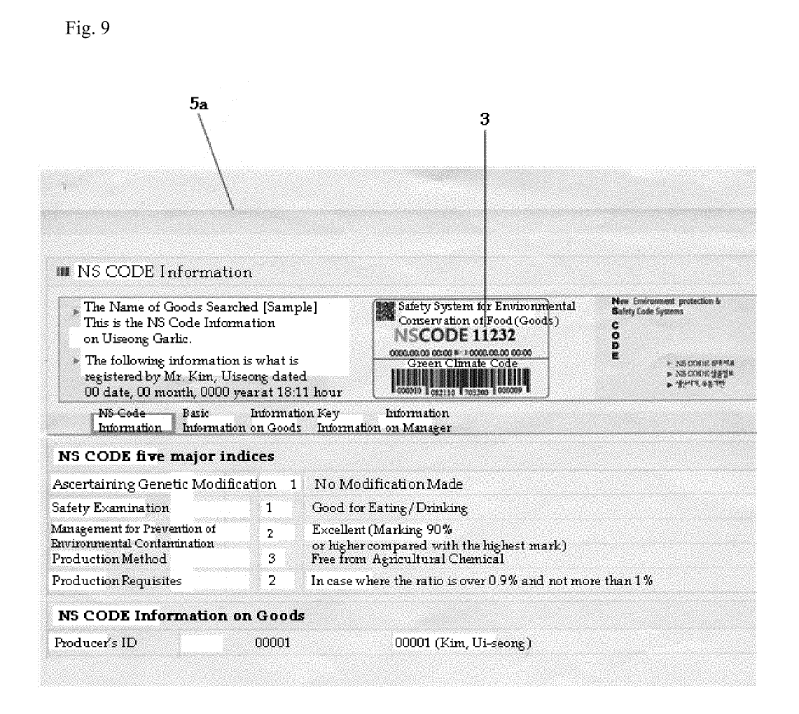

In case where one searches for the information on the goods via the NS Code, the process is the same as that used via the Green Climate Code, except that the search in this case is intended for the safety of the goods. FIG. 9 is an illustrative view of an information paper (5a) of the goods outputted by the search via the NS Code.

As mentioned above, only if the analytical data on the quality of soil, water and atmosphere, ascertained by an embodiment of the present invention, are not in breach of the value set forth by the international environmental standards, the Green Climate Code is generated and made available for attachment to the relevant goods. Therefore, the simple fact of the Green Climate Code being attached to the goods provides recognition to consumers that such goods are environment-friendly, excellent goods. Furthermore, thanks to the Green Climate Code and via the mobile and composite means of communication and the Internet of Things, the macro- and micro-information on the provenance of the goods stored in the database is made available in a transparent manner, thereby enhancing the credibility of the goods and promoting the consumers' purchasing power. As a result, the producers produce the goods in such a way as to contribute to the protection from climate change from the industrial aspect.

### CODES USED

1: Green Climate Platform; 2: one-dimensional Green Climate Code
2a: two-dimensional Green Climate Code; 3: NS Code
4: packaging paper; 5, 5a: information paper; DB: database
G1: Map of production site; G2, G3: satellite photograph of production site
P10: data input port; P20: data input control server
P30: database multiple unit control port

1. A satellite information system for protection from climate change characterized in that it consists of a combination of a Green Climate Platform comprising a plurality of databases storing satellite-collected macro-information incorporating various analytical data on the quality of soil, water and atmosphere of the production site of the origin state of the goods, as well as micro-information on the safety of goods, environmental management and the actual result of such management put into practice, the personal history of the producer of the goods, etc.; and a Green Climate Code provided with a search function for the information on the goods stored in the databases; and an NS Code having a search function for the genetic safety of the goods

2. A satellite information system for protection from climate change as claimed in claim 1, characterized in that the system enables one to search for the information on the goods, wherein the Green Climate Platform comprises a Data Input Port (P10), a Data Input Control Server (P20), and a Data Multiple Unit Control Port (P30); and the databases consist of a database (N10), which is designed to input and store the address of the origin state and the provenance and the satellite coordinate thereof; a database (N20), which is designed to input and store satellite-collected integrated data on the quality of soil, water and atmosphere of the origin state and the provenance; a database (N30), which is designed to input and store the micro-information on the analytical data on the soil of the production site; a database (N40), which is designed to input and store the micro-information on the analytical data on the quality of water of the production site; a database (N50), which is designed to input and store the micro-information on the analytical data on the atmosphere of the production site; a database (N60), which is designed to input and store the goods classification data based on the HS standards; a database (N70), which is designed to input and store the genetic analysis data; a database (N80), which is designed to input and store the analytical data on the safety of goods and food; a database (N90), which is designed to input and store the result of the environmental production management put into practice; and a database (N100), which is designed to input and store the information on the producer's personal history.

3. A satellite information system for protection from climate change as claimed in claim 1, wherein the Green Climate Code consists of five-digit numbered producer identification code, one-digit numbered check code, three-digit numbered origin state code, which is identical with the state code for the international phone call; three-digit numbered provenance code, which is identical with the area code of the origin state for a telephone call, six-digit numbered goods classification code unique to the goods, and the six-digit numbered code for a serial number for shipment of goods.

4. A satellite information system for protection from climate change as claimed in claim 1, wherein the NS Code comprises the first index on genetic information, the second index on safety information, the third index on the prevention of environmental contamination, the fourth index on production method, and the fifth index on production requisites, and wherein each index is shown in grades ranging from one to nine.

5. A satellite information system for protection from climate change as claimed in claim 1, wherein the search for and identification of the information on the goods stored in the databases of the Green Climate Platform is made possible via the Green Climate Code and the NS Code to be shown on the goods.
